(19) United States
(12) Patent Application Publication
(10) Pub. No.: US 2014/0036389 A1
(43) Pub. Date: Feb. 6, 2014

(54) SPINDLE MOTOR AND HARD DISK DRIVE INCLUDING THE SAME

(71) Applicant: SAMSUNG ELECTRO-MECHANICS CO., LTD., Suwon (KR)

(72) Inventor: Hoon Hee HAN, Suwon (KR)

(73) Assignee: Samsung Electro-Mechanics Co., Ltd., Suwon (KR)

(21) Appl. No.: 13/761,841

(22) Filed: Feb. 7, 2013

(30) Foreign Application Priority Data
Aug. 6, 2012 (KR) 10-2012-0085881

(51) Int. Cl. H02K 5/16

(52) U.S. Cl. CPC H02K 5/16
USPC 360/99.08; 310/90

(57) ABSTRACT

There are provided a spindle motor and a hard disk drive including the same, the spindle motor including: a thrust member fixed to a base member; a shaft fixed to the thrust member; a sleeve disposed above the thrust member, rotatably installed with respect to the shaft, and including a catching portion protruding outwardly from a lower portion thereof in a radial direction; a rotor hub coupled to the sleeve and rotating together therewith; and a stopper disposed above the catching portion and fixed to the base member.

### CROSS-REFERENCE TO RELATED APPLICATIONS

This application claims the priority of Korean Patent Application No. 10-2012-0085881 filed on Aug. 6, 2012, in the Korean Intellectual Property Office, the disclosure of which is incorporated herein by reference.

### BACKGROUND OF THE INVENTION

1. Field of the Invention

The present invention relates to a spindle motor and a hard disk drive including the same.

2. Description of the Related Art

A fixed shaft-type spindle motor in which a shaft having excellent vibration characteristics is fixed to a casing of a hard disk driving device is generally mounted in an information recording and reproducing device such as a hard disk driving device for a server.

That is, the shaft may be fixedly installed in the spindle motor mounted in a hard disk driving device for a server in order to prevent information recorded on the disk from being damaged and becoming unrecordable or unreadable due to an increase in the amplitude of vibration of a rotor caused by external impacts.

As described above, in the case in which the fixed shaft-type shaft is provided, thrust members are fixedly provided on upper and lower portions of the shaft to form thrust dynamic pressure bearings with a sleeve disposed therebetween.

However, in the case in which upper and lower thrust dynamic pressure bearings are provided, since intervals between the upper and lower thrust members and the sleeve may be relatively short, friction may be generated, and thus, current for driving the spindle motor may be consumed in significant amounts.

The Related Art Document described below relates to a fixed shaft-type spindle motor including upper and lower thrust members 230 and 220. As shown in FIG. 4, a sleeve 310 is disposed between the upper and lower thrust members 230 and 220, and thrust dynamic pressure bearings are formed between the upper and lower thrust members 230 and 220 and the sleeve 310, such that a significant amount of current may be consumed in driving the spindle motor.

### RELATED ART DOCUMENT

(Patent Document 1) Korean Patent Laid-open Publication No. 2006-0079630

### SUMMARY OF THE INVENTION

An aspect of the present invention provides a spindle motor capable of reducing current consumption by allowing a thrust dynamic pressure bearing to be formed in a single portion thereof.

According to an aspect of the present invention, there is provided a spindle motor including: a thrust member fixed to a base member; a shaft fixed to the thrust member; a sleeve disposed above the thrust member, rotatably installed with respect to the shaft, and including a catching portion protruding outwardly from a lower portion thereof in a radial direction; a rotor hub coupled to the sleeve and rotating together therewith; and a stopper disposed above the catching portion and fixed to the base member.

The stopper may be coupled to the base member to be disposed above the thrust member.

The base member may include a coupling part protruding upwardly in an inner portion thereof, and the stopper may be fixed to an inner peripheral surface of the coupling part.

The stopper may include a strength reinforcement portion extended from a lower portion thereof to be fitted between the thrust member and the coupling part of the base member.

The stopper may include a flange extended outwardly from a distal end of the strength reinforcement portion in the radial direction to be caught by a lower surface of the base member.

The lower surface of the base member may be provided with a flange accommodating groove in which the flange is caught.

The sleeve may form a liquid-vapor interface between the sleeve and the stopper.

A thrust dynamic pressure groove may be formed in at least one of an upper surface of the thrust member or a lower surface of the sleeve.

The spindle motor may further include a cap member fixed to an upper end portion of the shaft and forming a liquid-vapor interface between the cap member and the sleeve.

According to another aspect of the present invention, there is provided a hard disk drive including: the spindle motor as described above rotating a disk by power applied through a substrate; a magnetic head recording data on the disk and reproducing data from the disk; and a head transfer part transferring the magnetic head to a predetermined position above the disk.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating a spindle motor according to an embodiment of the present invention;

FIG. 2 is an enlarged view of part A of FIG. 1;

FIG. 3 is a partially cut-away exploded perspective view illustrating a sleeve, a cap member, and a thrust member according to an embodiment of the present invention;

FIG. 4 is a view illustrating the configuration of a spindle motor according to an embodiment of the present invention;

FIGS. 5A through 5c are partially cut-away perspective views of a stopper according to an embodiment of the present invention;

FIGS. 6A and 6B are partially cut-away perspective views illustrating a structure in which a stopper is fixed to a base member or a thrust member according to an embodiment of the present invention; and

FIG. 7 is a schematic cross-sectional view illustrating a recording disk driving device having a motor mounted therein according to an embodiment of the present invention.

### DETAILED DESCRIPTION OF THE EMBODIMENTS

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

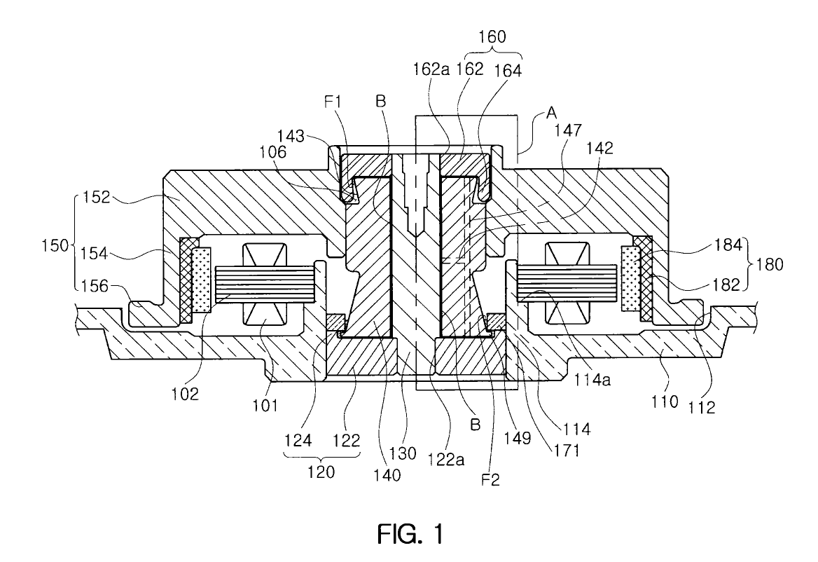

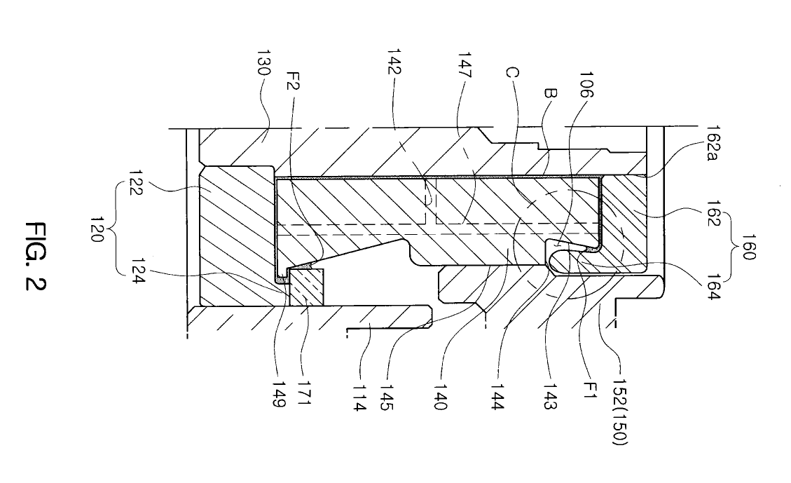

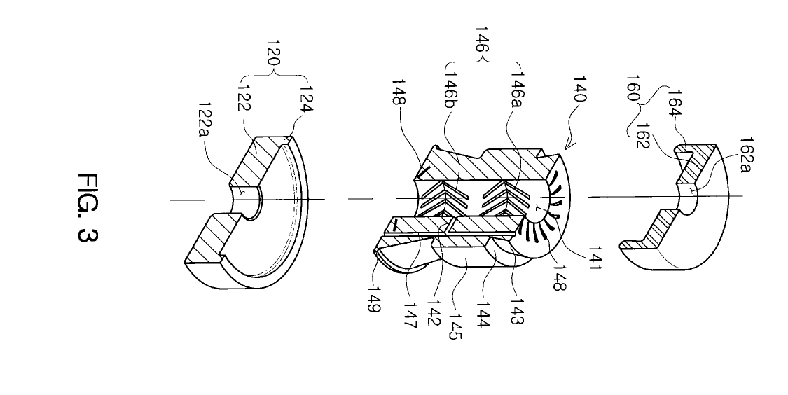

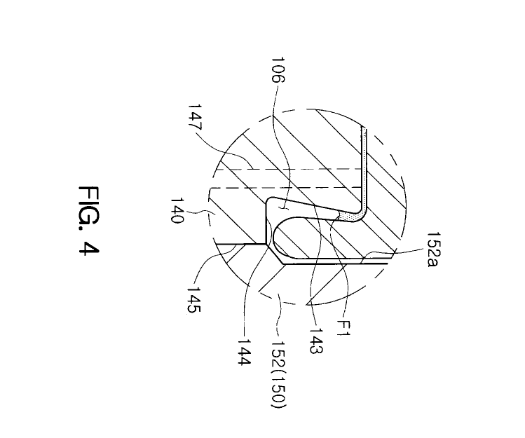

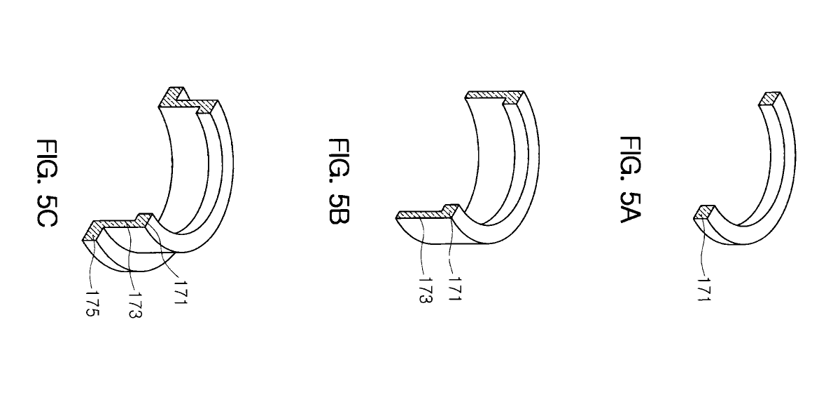

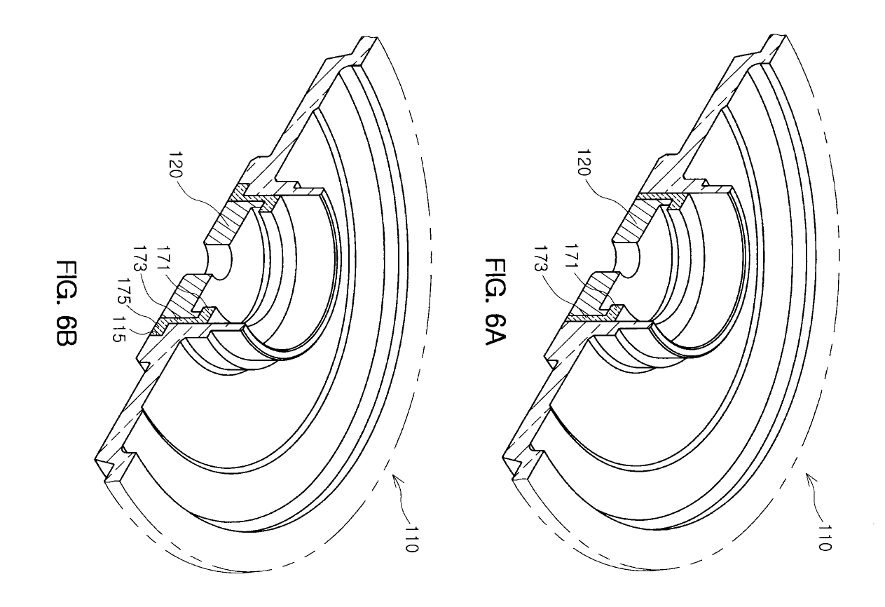

FIG. 1 is a schematic cross-sectional view illustrating a spindle motor according to an embodiment of the present invention; FIG. 2 is an enlarged view of part A of FIG. 1; FIG. 3 is a partially cut-away exploded perspective view illustrating a sleeve, a cap member, and a thrust member according to the embodiment of the present invention; FIG. 4 is a view illustrating the configuration of the spindle motor according to the embodiment of the present invention; FIGS. 5A through 5c are partially cut-away perspective views of a stopper according to the embodiment of the present invention; and FIGS. 6A and 6B are partially cut-away perspective views illustrating a structure in which the stopper is fixed to a base member or the thrust member according to the embodiment of the present invention.

Referring to FIGS. 1 through 6, a spindle motor 100 according to the embodiment of the present invention may include a base member 110, a thrust member 120, a shaft 130, a sleeve 140, a rotor hub 150, a cap member 160, and a stopper 171.

Here, terms with respect to directions will be defined. As viewed in FIG. 1, an axial direction refers to a vertical direction, that is, a direction from a lower portion of the shaft 130 toward an upper portion thereof or a direction from the upper portion of the shaft 130 toward the lower portion thereof, a radial direction refers to a horizontal direction, that is, a direction from the shaft 130 toward an outer peripheral surface of the rotor hub 150 or from the outer peripheral surface of the rotor hub 150 toward the shaft 130, and a circumferential direction refers to a rotation direction at a predetermined radius from the center of rotation.

The base member 110 may include a mounting groove 112 so that a predetermined space is formed between the base member 110 and the rotor hub 150. In addition, the base member 110 may include a coupling part 114 extended in an upward axial direction and having a stator core 102 installed on an outer peripheral surface thereof.

In addition, the coupling part 114 may include a seating surface 114a provided on the outer peripheral surface thereof so that the stator core 102 may be seated and installed thereon. Further, the stator core 102 seated on the coupling part 114 may be disposed above the mounting groove 112 of the base member 110.

Here, the base member 110 may be manufactured using aluminum (Al) in a die-casting scheme or be manufactured by performing plastic working (for example, press working) on a steel sheet.

Meanwhile, the base member 110 may include a flange accommodating groove 115 so that a flange 175 of a stopper 171 to be described below may be coupled thereto. A description thereof will be provided below.

The thrust member 120 may be fixed to the base member 110. That is, the thrust member 120 may be insertedly installed in the coupling part 114. More specifically, the thrust member 120 may be installed such that an outer peripheral surface thereof is bonded to an inner peripheral surface of the coupling part 114.

Meanwhile, the thrust member 120 may include a disk part 122 having an outer peripheral surface fixedly installed in the base member 110 and an extension part 124 extended upwardly from an outer edge of the disk part 122 in the axial direction. The extension part 124 may have a height slightly higher than a thickness of a catching portion 149 provided in the sleeve 140 to be described below. That is, the stopper 171 may be disposed above the extension part 124 of the thrust member 120, such that the catching portion 149 may be caught. Therefore, the extension part 124 may provide a space in which the catching portion 149 may move between the stopper 171 and the disk part 122 in the axial direction.

That is, the thrust member 120 may have a cup shape with a hollow portion and an installation hole 122a provided at the center of the hollow portion, and the shaft 130 is coupled to the installation hole 122a. That is, the thrust member 120 may have a ‘ [symbol] ’ shaped cross section. The disk part 122 may be provided with the installation hole 122a in which the shaft 130 is installed, and the shaft 130 may be insertedly mounted in the installation hole 122a.

In addition, the thrust member 120 may be included, together with the base member 110, in a fixed member, that is, a stator.

Meanwhile, an outer surface of the thrust member 120 may be bonded to an inner surface of the base member 110 by an adhesive and/or welding. In other words, the outer surface of the thrust member 120 may be fixedly bonded to an inner surface of the coupling part 114 of the base member 110.

In addition, a thrust dynamic pressure groove 148 for generating thrust fluid dynamic pressure may be formed in at least one of an upper surface of the thrust member 120 and a bottom surface of the sleeve 140. A description thereof will be provided with reference to FIG. 3 in detail below.

The shaft 130 may be fixed to the thrust member 120. That is, a lower end portion of the shaft 130 may be inserted into the installation hole 122a formed in the disk part 122 of the thrust member 120.

In addition, the lower end portion of the shaft 130 may be bonded to an inner surface of the disk part 122 by an adhesive and/or welding. Therefore, the shaft 130 may be fixed thereto.

Meanwhile, the shaft 130 may be also included, together with the thrust member 120 and the base member 110, in the fixed member, that is, the stator.

Meanwhile, an upper surface of the shaft 130 may be provided with a coupling unit, for example, a screw part having a screw screwed thereto so that a cover member (not shown) may be fixedly installed thereon.

The sleeve 140 may be rotatably installed with respect to the shaft 130. To this end, the sleeve 140 may include a through-hole 141 into which the shaft 130 is inserted. Meanwhile, an inner peripheral surface of the sleeve 140 and an outer peripheral surface of the shaft 130 may be disposed to be spaced apart from each other by a predetermined interval to form a bearing clearance B therebetween. In addition, the bearing clearance B may be filled with a lubricating fluid.

Meanwhile, the sleeve 140 may have an inclined part 143 formed on an upper end portion thereof to form a liquid-vapor interface together with the cap member 160, wherein the inclined part 143 has a greater outer diameter in an upper portion thereof than in a lower portion thereof.

In other words, the inclined part 143 having the greater outer diameter in the upper portion thereof than in the lower portion thereof may be formed on the upper end portion of the sleeve 140 so that a first liquid-vapor interface F1 may be formed in a space between an outer peripheral surface of the sleeve 140 and an inner peripheral surface of the cap member 160.

Meanwhile, the sleeve 140 may include a step surface 144 stepped in the upper end portion thereof in order to form a sealing groove 106. A detailed description of the step surface 144 will be provided below.

In addition, the sleeve 140 may have the rotor hub 150 bonded to the outer peripheral surface thereof. That is, a portion of the sleeve 140 under the step surface 144 may have a shape corresponding to that of an inner surface of the rotor hub 150, such that the rotor hub 150 may be fixedly installed thereon. That is, the sleeve 140 may include a bonding surface 145 formed on the outer peripheral surface thereof.

Meanwhile, a lower end portion of the outer peripheral surface of the sleeve 140 may be inclined upwardly in an inner radial direction to form a liquid-vapor interface together with an inner peripheral surface of the stopper 171 to be described below.

That is, the lower end portion of the sleeve 140 may be inclined upwardly in the inner radial direction so that a second liquid-vapor interface F2 may be formed in a space between the outer peripheral surface of the sleeve 140 and the stopper 171.

As described above, since the second liquid-vapor interface F2 is formed in the space between the lower end portion of the sleeve 140 and the stopper 171, the lubricating fluid contained in the bearing clearance B may form the first and second liquid-vapor interfaces F1 and F2.

In addition, the sleeve 140 may include a radial dynamic pressure groove 146 formed in the inner surface thereof in order to generate fluid dynamic pressure through the lubricating fluid contained in the bearing clearance B at the time of rotation of the sleeve 140. That is, the radial dynamic pressure groove 146 includes upper and lower radial dynamic pressure grooves 146a and 146b, as shown in FIG. 3.

However, the radial dynamic pressure groove 146 is not limited to being formed in the inner surface of the sleeve 140, but may be formed in the outer peripheral surface of the shaft 130. The radial dynamic pressure groove 146 may have various patterns such as a herringbone pattern, a spiral pattern, a helix pattern, or the like.

Further, the sleeve 140 may further include a circulation hole 147 allowing the upper and lower surfaces thereof to be in communication with each other. The circulation hole 147 may allow air bubbles contained in the lubricating fluid of the bearing clearance B to be discharged to the outside thereof, and facilitate circulation of the lubricating fluid.

Further, the sleeve 140 may further include a communication hole 142 allowing the bearing clearance B formed by the sleeve 140 and the shaft 130 and the circulation hole 147 to be in communication with each other. Therefore, the communication hole 142 may prevent the generation of negative pressure between the radial dynamic pressure grooves 146a and 146b.

Further, the sleeve 140 may include the catching portion 149 protruding outwardly from the lower portion thereof in the radial direction. The catching portion 149 may be caught by the stopper 171 to limit the floating of the sleeve 140 in the axial direction.

The rotor hub 150 may be coupled to the sleeve 140 to thereby rotate together with the sleeve 140.

The rotor hub 150 may include a rotor hub body 152 including an insertion part 152a formed therein, the insertion part 152a having the cap member 160 insertedly disposed in an inner portion thereof, a mounting part 154 extended from an edge of the rotor hub body 152 and including a magnet assembly 180 mounted on an inner surface thereof, and an extension part 156 extended from an edge of the mounting part 154 in an outer radial direction.

Meanwhile, a lower end portion of an inner surface of the rotor hub body 152 may be bonded to the outer surface of the sleeve 140. That is, the lower end portion of the inner surface of the rotor hub body 152 may be bonded to the bonding surface 145 of the sleeve 140 by an adhesive and/or welding.

Therefore, the sleeve 140 may rotate together with the rotor hub 150 at the time of rotation of the rotor hub 150.

In addition, the mounting part 154 may be extended downwardly from the rotor hub body 152 in the axial direction. Further, the mounting part 154 may include the magnet assembly 180 fixed to the inner surface thereof.

Meanwhile, the magnet assembly 180 may include a yoke 182 fixed to the inner surface of the mounting part 154 and a magnet 184 installed on an inner peripheral surface of the yoke 182.

The yoke 182 may serve to direct a magnetic field from the magnet 184 toward the stator core 102 to increase magnetic flux density. Meanwhile, the yoke 182 may have a circular ring shape. In order to increase magnetic flux density with the magnetic field generated from the magnet 184, one end portion of the yoke 182 may be bent.

The magnet 184 may have an annular ring shape and may be a permanent magnet generating a magnetic field having a predetermined strength by alternately magnetizing an N pole and an S pole in the circumferential direction.

Meanwhile, the magnet 184 may be disposed to face a front end of the stator core 102 having a coil 101 wound therearound and generate driving force through electromagnetic interaction with the stator core 102 having the coil 101 wound therearound so that the rotor hub 150 may rotate.

That is, when power is supplied to the coil 101, the driving force rotating the rotor hub 150 may be generated by the electromagnetic interaction between the stator core 102 having the coil 101 wound therearound and the magnet 184 disposed to face the stator core 102, such that the rotor hub 150 may rotate together with the sleeve 140.

The cap member 160 may be fixed to the upper end portion of the shaft 130 and form the liquid-vapor interface together with the sleeve 140.

Meanwhile, the cap member 160 may include a body 162 having an inner surface bonded to the shaft 130 and a protrusion part 164 extended from the body 162 to thereby form the liquid-vapor interface together with the inclined part 143.

The protrusion part 164 may be extended downwardly from the body 162 in the axial direction and have an inner surface disposed to face the inclined part 143.

In addition, the protrusion part 164 may be extended from the body 162 to be parallel to the shaft 130.

Further, the cap member 160 may be insertedly disposed in a space formed by an upper end portion of the outer peripheral surface of the shaft 130, the outer surface of the sleeve 140, and the inner surface of the rotor hub 150.

In addition, the cap member 160, together with the base member 110, the thrust member 120, and the shaft 130, may be a fixed member configuring the stator.

Meanwhile, since the cap member 160 is fixed to the shaft 130 and the sleeve 140 rotates together with the rotor hub 150, the first liquid-vapor interface F1 formed in the space between the inclined part 143 of the sleeve 140 and the protrusion part 164 may be inclined toward the inclined part 143 of the sleeve 140 at the time of rotation of the sleeve 140, as shown in FIG. 4.

That is, the first liquid-vapor interface F1 may be inclined toward the outer peripheral surface of the sleeve 140, whereby scattering of the lubricating fluid may be further reduced by centrifugal force.

In addition, an outer peripheral surface of the cap member 160 and the inner surface of the rotor hub 150 disposed to face the outer peripheral surface of the cap member 160 may form a labyrinth seal. That is, the outer surface of the cap member 160 and the inner surface of the rotor hub body 152 may be spaced apart from each other by a predetermined interval and form the labyrinth seal to suppress the air containing evaporated lubricating fluid from moving to the outside.

Therefore, the movement of the air containing the evaporated lubricating fluid to the outside may be suppressed, whereby a reduction in the amount of lubricating fluid may be suppressed.

In addition, the outer peripheral surface of the cap member 160 and the inner surface of the rotor hub body 152 may have a clearance of 0.3 mm or less formed therebetween.

Meanwhile, a thrust dynamic pressure groove for generating thrust dynamic pressure may be formed in at least one of a lower surface of the cap member 160 and the upper surface of the sleeve 140 disposed to face the lower surface of the cap member 160.

In addition, the cap member 160 may also serve as a sealing member preventing the lubricating fluid contained in the bearing clearance B from being leaked upwardly.

In addition, the clearance between the cap member 160 and the rotor hub 150 may have a narrow interval to suppress the air containing the evaporated lubricating fluid from moving to the outside, whereby the reduction in the amount of lubricating fluid contained in the bearing clearance B may be suppressed.

Meanwhile, with regard to the rotating member (that is, the sleeve) and the fixed member (that is, the cap member and the thrust member) that form the liquid-vapor interfaces, that is, the first and second liquid-vapor interfaces F1 and F2, the rotating member, that is, the sleeve 140 may be disposed inside the fixed member in the radial direction, whereby the scattering of the lubricating fluid may be reduced by centrifugal force.

The stopper 171 may be fixed to the base member 110 to be positioned above the catching portion 149 provided in the sleeve 140. More specifically, the stopper may be fixed to the inner peripheral surface of the coupling part 114 provided in the base member 110.

The stopper 171 may be fixed by various coupling methods such as a sliding method, a press-fitting method, an adhesive bonding method, a welding method, or the like.

The stopper 171 may be disposed above the catching portion 149, such that the catching portion 149 is caught by a lower portion of the stopper 171, such that over-floating of the sleeve 140 may be prevented.

In addition, the stopper 171 may form the liquid vapor interface F2 in which the lubricating fluid is sealed between the stopper 171 and the sleeve 140.

Meanwhile, the stopper 171 may be provided to have a ring shape (please see FIG. 5A). In addition, the stopper 171 may include a strength reinforcement portion 173 extended from the lower portion thereof to be fitted between the thrust member 120 and the coupling part 114 of the base member 110 (please see FIGS. 5B and 6A). Further, the stopper 171 may include the flange 175 extended outwardly from a distal end of the strength reinforcement portion 173 in the radial direction to be caught by a lower surface of the base member 110. Here, the lower surface of the base member 110 may be provided with the flange accommodating groove 115 in which the flange 175 is held, such that the flange 175 may be placed therein (please see FIGS. 5C and 6B).

In the case in which the stopper 171 includes the strength reinforcement portion 173, the strength reinforcement portion 173 may be fixed to at least one of the thrust member 120 and the base member 110. As a fixing method, various coupling methods such as a press-fitting method, a sliding method, an adhesive bonding method, a welding method, or the like may be used.

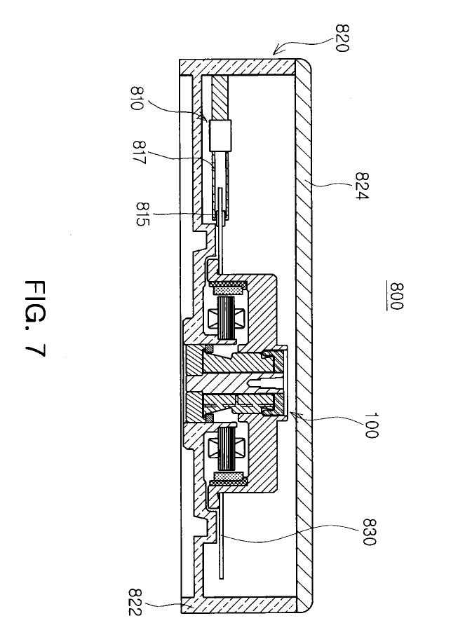

FIG. 7 is a schematic cross-sectional view illustrating a recording disk driving device having a motor mounted therein according to an embodiment of the present invention.

Referring to FIG. 7, a recording disk driving device 800 including the motor 100 mounted therein according to the embodiment of the present invention may be a hard disk driving device and include the motor 100, a head transfer part 810, and a housing 820.

The motor 100 has all the characteristics of the motor according to the aforementioned embodiment of the present invention and may have a recording disk 830 mounted thereon.

The head transfer part 810 may transfer a magnetic head 815 detecting information from the recording disk 830 mounted in the motor 100 on a surface of the recording disk from which the information is to be detected.

Here, the magnetic head 815 may be disposed on a support portion 817 of the head transfer part 810.

The housing 820 may include a motor mounting plate 822 and a top cover 824 shielding an upper part of the motor mounting plate 822 in order to form an internal space receiving the motor 100 and the head transfer part 810.

As set forth above, according to embodiments of the present invention, a spindle motor capable of reducing current consumption by allowing a thrust dynamic pressure bearing to be formed in a single portion thereof may be provided.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a thrust member fixed to a base member;
a shaft fixed to the thrust member;
a sleeve disposed above the thrust member, rotatably installed with respect to the shaft, and including a catching portion protruding outwardly from a lower portion thereof in a radial direction;
a rotor hub coupled to the sleeve and rotating together therewith; and
a stopper disposed above the catching portion and fixed to the base member.

2. The spindle motor of claim 1, wherein the stopper is coupled to the base member to be disposed above the thrust member.

3. The spindle motor of claim 1, wherein the base member includes a coupling part protruding upwardly in an inner portion thereof, and
the stopper is fixed to an inner peripheral surface of the coupling part.

4. The spindle motor of claim 3, wherein the stopper includes a strength reinforcement portion extended from a lower portion thereof to be fitted between the thrust member and the coupling part of the base member.

5. The spindle motor of claim 4, wherein the stopper includes a flange extended outwardly from a distal end of the strength reinforcement portion in the radial direction to be caught by a lower surface of the base member.

6. The spindle motor of claim 5, wherein the lower surface of the base member is provided with a flange accomodating groove in which the flange is caught.

7. The spindle motor of claim 1, wherein the sleeve forms a liquid-vapor interface between the sleeve and the stopper.

8. The spindle motor of claim 1, wherein a thrust dynamic pressure groove is formed in at least one of an upper surface of the thrust member or a lower surface of the sleeve.

9. The spindle motor of claim 1, further comprising a cap member fixed to an upper end portion of the shaft and forming a liquid-vapor interface between the cap member and the sleeve.

10. A hard disk drive comprising:
the spindle motor of claim 1 rotating a disk by power applied through a substrate;
a magnetic head recording data on the disk and reproducing data from the disk; and
a head transfer part transferring the magnetic head to a predetermined position above the disk.
